(19) United States
(12) Patent Application Publication
(10) Pub. No.: US 2021/0156314 A1
(43) Pub. Date: May 27, 2021

(54) METHOD FOR ACTIVE FAULT TOLERANT CONTROL OF TURBOFAN ENGINE CONTROL SYSTEM

(71) Applicant: DALIAN UNIVERSITY OF TECHNOLOGY, Dalian, Liaoning (CN)

(72) Inventors: Nan DING, Dalian, Liaoning (CN); Yanhua MA, Dalian, Liaoning (CN); Yanlei GAO, Dalian, Liaoning (CN); Xian DU, Dalian, Liaoning (CN); Rui WANG, Dalian, Liaoning (CN)

(21) Appl. No.: 16/770,801

(22) PCT Filed: Nov. 5, 2019
(86) PCT No.: PCT/CN2019/115497

§ 371 Date: Jun. 8, 2020

(30) Foreign Application Priority Data
Aug. 13, 2019 (CN) 201910742832.3

(51) Int. Cl. F02C 9/00; G05B 23/02; G06F 17/16

(52) U.S. Cl. CPC F02C 9/00; G05B 23/0254; G06F 17/16; F05D 2270/71; F05D 2270/803; F05D 2270/305; F05D 2270/46; F05D 2220/323

(57) ABSTRACT

A method for active fault tolerant control of a turbofan engine control system designs a linear parameter varying gain scheduling robust tracking controller with good dynamic performance. Adaptive estimation of fault amplitude of a sensor and an actuator is realized according to the change of the operating state of the turbofan engine to accurately reconfigure a fault signal. An active fault tolerant control strategy based on a virtual actuator is designed according to a fault estimation result. Without redesigning the controller, through the designed active fault tolerant control strategy, on the premise of ensuring the stability of the control system, a control effect similar to that of the control system without fault is obtained.

### TECHNICAL FIELD

The present invention relates to a method for active fault tolerant control of a turbofan engine control system, belongs to the technical field of air-craft control, and particularly relates to a method for fault estimation and active fault tolerant control for multi-concurrent faults of both actuators and sensors in a turbofan engine control system and in the presence of external disturbance.

### BACKGROUND

The turbofan engine is widely used in commercial and military aero-crafts, and its safety and reliability are closely related to flight safety. The control system is used as the “brain” of the turbofan engine to ensure the safety and performance of the turbofan engine within a full flight envelope. The functions of the control system need to be realized depending on a large number of sensors and actuators. If some devices fail, it is difficult to realize desired control effects and the flight safety may be even affected. Therefore, it is of great significance to monitor the performance of the turbofan engine control system, estimate and warn the fault state in real time and take corresponding fault tolerant control measures.

The literature shows that the existing turbofan engine control system adopts fault diagnosis and passive fault tolerant control for the fault processing modes of the sensor and the actuator. That is, the control algorithm uses a control mode of a combination of PID and Min/Max switching. It is judged whether the sensor and the actuator of the control system fail according to the working condition of the turbofan engine, output rotary speed, temperature, pressure and other measurable parameters based on a Kalman filter. When a fault occurs, passive fault tolerant control based on hardware redundancy and control loop switching is further adopted. Although the existing methods can ensure the safe operation of the turbofan engine, the methods are conservative, which is mainly reflected in the following points: firstly, the PID+Min/Max control mode introduces undesirable characteristics in the aspects of control bandwidth, amplitude/phase margin and response speed of the aeroengine, and it is difficult to obtain faster dynamic response characteristics. Secondly, only the fault is detected, that is, if it is judged that a fault occurs, the fault is processed by a conservative passive fault tolerant control mode such as hardware redundancy or control loop switching. The hardware redundancy inevitably causes waste of hardware resources. The fault tolerant control based on controller switching is to ensure the safe operation of the aeroengine at the expense of some performance criteria. Finally, as the complexity of the turbofan engine control system is increased, the types and number of the faults are also increased. Therefore, the traditional passive fault tolerant control has great limitations, that is, all possible fault conditions need to be considered in advance, causing that the controller is conservative. It is worth mentioning that the turbofan control system is often disturbed by noise signals. The existing methods have no ideal solution for the fault tolerant control of the sensor and actuator faults of the turbofan engine control system in processing interference signals.

### SUMMARY

In view of the problems that the existing fault diagnosis and fault tolerant control method of the sensor and the actuator of the turbofan engine control system is conservative and difficult to ensure the robustness of the control system under a disturbance environment, the present invention provides a method for active fault tolerant control of a turbofan engine control system. Firstly, a linear parameter varying (LPV) gain scheduling robust tracking controller with good dynamic performance is designed. Further, adaptive estimation of fault amplitude of the sensor and the actuator is realized according to the change of the operating state of the turbofan engine to accurately reconfigure a fault signal. Then, an active fault tolerant control strategy based on a virtual actuator is designed according to the fault estimation result. Without redesigning the controller, through the designed active fault tolerant control strategy, on the premise of ensuring the stability of the control system, a control effect similar to that of the control system without fault is obtained.

To achieve the above purpose, the technical solution adopted by the present invention comprises the following steps:

A method for active fault tolerant control of a turbofan engine control system comprises the following steps:

step 1: establishing a turbofan engine LPV model based on turbofan engine test experimental data:

$$\{ \begin{matrix}\dot{x} = A ( λ ) x + B ( λ ) {u}_{c} + Ed \\ y = Cx + Gd\end{matrix} \qquad ( 1 )$$

wherein x∈Rⁿ is a state variable u_{c}∈R^{m} is the control input of a turbofan engine; d∈R^{q} is a disturbance signal; output is y∈R^{p}; the value of a scheduling parameter λ is a normalized relative conversion speed of high pressure rotors of the turbofan engine; λₘᵢₙ≤λ≤λₘₐₓ; λₘᵢₙ and λₘₐₓ are respectively a minimum value and a maximum value of the scheduling parameter; system matrices are A(λ)∈R^{n×n}, B(λ)∈R^{n×m}, C∈R^{n×m}, E∈R^{n×q}, G∈R^{p×q}; R^{(⋅)} represents a (⋅)-dimensional real column vector; and R^{a×b} represents a a×b-dimensional real matrix;

step 2: designing a LPV gain scheduling robust tracking controller for the turbofan engine LPV model with disturbance;

step 2.1: introducing a new state variable xₑ, defined as

xₑ=∫₀ⁱe(s)ds=∫₀ⁱ(y(s)−yᵣ(s))ds (2)

wherein e(⋅) is a tracking error and y_{r(⋅)} is a desired tracking signal: rewriting formula (1) into a formula (3) of a generalized form

$$\{ \begin{matrix}\dot{\overline{x}} = \overline{A} ( λ ) \overline{x} + {\overline{B}}_{1} \overline{w} + {\overline{B}}_{2} ( λ ) {u}_{c} \\ \overline{z} = {\overline{C}}_{1} \overline{x} + {\overline{D}}_{11} \overline{w}\end{matrix} \\ wherein \overline{x} = [ \begin{matrix}x \\ {x}_{e}\end{matrix} ] , \overline{w} = [ \begin{matrix}d \\ {y}_{r}\end{matrix} ] , \overline{z} = [ \begin{matrix}e \\ {x}_{e}\end{matrix} ] , \overline{A} ( λ ) = [ \begin{matrix}A ( λ ) & 0 \\ C & 0\end{matrix} ] , \\ {\overline{B}}_{1} = [ \begin{matrix}E & 0 \\ G & - I\end{matrix} ] , {\overline{B}}_{2} ( λ ) = [ \begin{matrix}B ( λ ) \\ 0\end{matrix} ] , \\ {\overline{C}}_{1} = [ \begin{matrix}C & 0 \\ 0 & I\end{matrix} ] and {D}_{11} = [ \begin{matrix}G & - I \\ 0 & 0\end{matrix} ] ; \qquad ( 3 )$$

step 2.2: for the formula (3), constructing and solving the following linear matrix inequalities (LMIs):

$$[ \begin{matrix}( {\overline{A}}_{i} X + {\overline{B}}_{2 i} {V}_{i} ) + {( {\overline{A}}_{i} X + {\overline{B}}_{2 i} {V}_{i} )}^{T} & {\overline{B} }_{1} & {( {\overline{C}}_{1} X )}^{T} \\ 0 & - γ I & {\overline{D} }_{11}^{T} \\ 0 & 0 & - γ I\end{matrix} ] < 0 \qquad ( 4 )$$

wherein i=1, 2, Ā₂=Ā(λₘᵢₙ), Ā₂=Ā(λₘₐₓ) B̅₂₁=B̅₂(λₘᵢₙ) and B̅₂₂=B̅₂(λₘₐₓ); γ is a desired value of H_{∞} norm of a close loop transfer function T_{w̅z̅}(s) in the generalized form (3); I is an identity matrix; and the formula (4) is solved to obtain matrices X and Vᵢ;

step 2.3: computing the output of the LPV gain scheduling robust tracking controller:

$${u}_{c} = K ( λ ) \overline{x} = {\sum }_{i = 1}^{2} {α}_{i} {V}_{i} {X}^{- 1} \overline{x} \\ wherein K ( λ ) = {\sum }_{i = 1}^{2} {α}_{i} {V}_{i} {X}^{- 1} , {α}_{1} ( λ ) = \frac{{λ}_{max} - λ}{{λ}_{max} - {λ}_{min}} and {α}_{2} ( λ ) = \frac{λ - {λ}_{min}}{{λ}_{max} - {λ}_{min}} ; \qquad ( 5 )$$

step 3: for the turbofan engine LPV model with disturbance and sensor and actuator faults, establishing an adaptive fault estimator of the turbofan engine based on a robust H_{∞} optimization method to realize fault estimation of a sensor and an actuator;

step 3.1: considering that the turbofan engine control system has the actuator and sensor faults. and expressing a system with fault as shown in formula (6):

$$\{ \begin{matrix}{\dot{x}}_{f} = A ( λ ) {x}_{f} + {B}_{f} ( λ ) u + Ed + {F}_{f} ( λ ) f \\ {y}_{f} = {Cx}_{f} + Gd + {H}_{f} ( λ ) f\end{matrix} \qquad ( 6 )$$

wherein x∈Rⁿ is a state variable of the system with fault u∈R^{m} is control input of the system with fault; y_{f}∈R^{p} is measurement output of the system with fault; f=[fₐ^{T} fₛ^{T}]^{T}∈R^{l} is a fault signal; fₐ∈R^{l}^{₁} is an actuator fault; fₛ∈R^{l}^{₂} is a sensor fault; B_{f}(λ)∈R^{n×m} is a matrix of the system with fault; and F_{f}(λ)∈R^{n×l} and H_{f}(λ)∈R^{p×l} are respectively fault matrices of the actuator and the sensor;

step 3.2: separating a time varying part from a time invariant part in the formula (6), and rewriting into the following form

$$\{ \begin{matrix}[ \begin{matrix}{\dot{x}}_{e} \\ \hat{f} \\ {z}_{e λ}\end{matrix} ] = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] [ \begin{matrix}{x}_{e} \\ {u}_{e} \\ {w}_{e λ}\end{matrix} ] \\ {w}_{λ} = Λ {z}_{λ}\end{matrix} \qquad ( 7 )$$

wherein external input is w=[u^{T} d^{T} f^{T}]^{T}; z_{λ}, w_{λ}∈R^{r} are respectively input and output variables of a r-dimensional time varying subsystem Λ=λI in the formula (6): B_{f1}∈R^{n×r}, B_{f2}∈R^{n×(m+q+l)}, C_{f1}∈R^{r×n}, C_{f2}∈R^{p×n}, D_{f11}∈R^{r×r} D₁₂∈R^{r×(m+q+l)}, D_{f21}∈∈R^{p×r} and D_{f22}∈R^{p×(m+q+l)} are system state space matrices;

based on the formula (7), constructing a fault estimator state space expression as follows:

$$\{ \begin{matrix}[ \begin{matrix}{\dot{x}}_{e} \\ \hat{f} \\ {z}_{e λ}\end{matrix} ] = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] [ \begin{matrix}{x}_{e} \\ {u}_{e} \\ {w}_{e λ}\end{matrix} ] \\ {w}_{λ} = Λ {z}_{λ}\end{matrix} \qquad ( 8 )$$

wherein xₑ∈R^{k}, uₑ=[u^{T} y_{f}^{T}]^{T}∈R^{(p+m)} and \hat{f}∈R^{t} respectively represent a state variable, a control input and a fault estimation output of the fault estimator; z_{eλ}∈R^{r} and w_{eλ}∈R^{r} respectively represent an input and an output of the time varying part of the fault estimator; Aₑ∈R^{k×k}, Bₑ₁∈R^{k×(m+p)}, Bₑ₂∈R^{k×r}, Cₑ₁∈R^{l×k}, Cₑ₂∈R^{r×k}, Dₑ₁₁∈R^{l×(p+m)}, Dₑ₁₂∈R^{l×r}, Dₑ₂₁∈R^{r×(p+m)} and Dₑ₂₂∈R^{r×r} are fault estimator coefficient matrices to be designed;

step 3.3: constructing a state space joint representation of the formula (7) of the system with fault of the turbofan engine and the formula (8) of the fault estimator:

$$\{ \begin{matrix}[ \begin{matrix}{\dot{x}}_{f} \\ \frac{{\dot{x}}_{e}}{{z}_{e λ}} \\ \frac{{z}_{λ}}{{e}_{f}}\end{matrix} ] = [ \begin{matrix}{A}^{\_ } & {{B}^{\_ }}_{1} & {{B}^{\_ }}_{2} \\ {\overline{C}}_{1} & {{D}^{\_ }}_{11} & {{D}^{\_ }}_{12} \\ {\overline{C}}_{2} & {{D}^{\_ }}_{21} & {\overline{D} }_{22}\end{matrix} ] [ \begin{matrix}{\dot{x}}_{f} \\ \frac{{\dot{x}}_{e}}{{z}_{e λ}} \\ \frac{{z}_{λ}}{{e}_{f}}\end{matrix} ] \\ [ \begin{matrix}{w}_{λ} \\ {w}_{e λ}\end{matrix} ] = [ \begin{matrix}Λ & 0 \\ 0 & Λ\end{matrix} ] [ \begin{matrix}{z}_{λ} \\ {z}_{e λ}\end{matrix} ]\end{matrix} \qquad ( 9 )$$

wherein a fault estimate error is e_{f}=\hat{f}−f,

$$\begin{matrix}[ \begin{matrix}{A}^{\_ } & {\overline{B} }_{1} & {{B}^{\_ }}_{2} \\ {\overline{C}}_{1} & {{D}^{\_ }}_{11} & {{D}^{\_ }}_{12} \\ {\overline{C}}_{2} & {{D}^{\_ }}_{21} & {{D}^{\_ }}_{22}\end{matrix} ] = [ \begin{matrix}{A}_{0} & {B}_{01} & {B}_{02} \\ {C}_{01} & {D}_{01} & {D}_{02} \\ {C}_{02} & {D}_{03} & {D}_{04}\end{matrix} ] + [ \begin{matrix}{T}_{1} \\ {T}_{5} \\ {T}_{6}\end{matrix} ] Γ [ \begin{matrix}{T}_{2} & {T}_{3} & {T}_{4}\end{matrix} ] \\ {A}_{0} = [ \begin{matrix}A & 0 \\ 0 & 0\end{matrix} ] , {B}_{01} = [ \begin{matrix}0 & {B}_{f 1} \\ 0 & 0\end{matrix} ] , {B}_{02} = [ \begin{matrix}{B}_{f 2} \\ 0\end{matrix} ] & ( 10 ) \\ {C}_{01} = [ \begin{matrix}0 & 0 \\ {C}_{f 1} & 0\end{matrix} ] , {D}_{01} = [ \begin{matrix}0 & 0 \\ 0 & {D}_{f 11}\end{matrix} ] , {D}_{02} = [ \begin{matrix}0 \\ {D}_{f 12}\end{matrix} ] \\ {C}_{02} = [ \begin{matrix}0 & 0\end{matrix} ] , {D}_{03} = [ \begin{matrix}0 & 0\end{matrix} ] , {D}_{04} = {D}_{22} & ( 11 ) \\ {T}_{1} = [ \begin{matrix}0 & 0 & 0 \\ I & 0 & 0\end{matrix} ] , {T}_{2} = [ \begin{matrix}0 & I \\ {C}_{3} & 0 \\ 0 & 0\end{matrix} ] , {T}_{3} = [ \begin{matrix}0 & 0 \\ 0 & {D}_{31} \\ I & 0\end{matrix} ] \\ {T}_{4} = [ \begin{matrix}0 \\ {D}_{32} \\ 0\end{matrix} ] , {T}_{5} = [ \begin{matrix}0 & 0 & I \\ 0 & {D}_{13} & 0\end{matrix} ] , {T}_{6} = [ \begin{matrix}0 & {D}_{23} & 0\end{matrix} ] & ( 12 ) \\ Γ = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] {C}_{3} = [ \begin{matrix}0 \\ {C}_{f 2}\end{matrix} ] , {D}_{22} = [ \begin{matrix}0 & - I \\ 0 & 0\end{matrix} ] , \\ {D}_{23} = [ \begin{matrix}I \\ 0\end{matrix} ] , {D}_{31} = [ \begin{matrix}0 \\ {D}_{f 21}\end{matrix} ] , {D}_{32} = [ \begin{matrix}I & 0 & 0 \\ & {D}_{f 22} & \end{matrix} ] & ( 13 )\end{matrix}$$

and Γ are estimation matrices of the fault estimator;

step 3.4: setting

$$X = [ \begin{matrix}L & V \\ {V}^{T} & y\end{matrix} ] , {X}^{- 1} = [ \begin{matrix}J & W \\ {W}^{T} & Z\end{matrix} ]$$

wherein L, V and Y respectively represent sub-block matrices of X; and J, W and Z respectively represent sub-block matrices of X⁻¹;

constructing a matrix P and an inverse matrix \tilde{P} as shown in formula (14):

$$P = [ \begin{matrix}Q & S \\ {S}^{T} & R\end{matrix} ] = [ \begin{matrix}{Q}_{1} & {Q}_{2} & {S}_{1} & {S}_{2} \\ {Q}_{2}^{T} & {Q}_{3} & {S}_{3} & {S}_{4} \\ {S}_{1}^{T} & {S}_{3}^{T} & {R}_{1} & {R}_{2} \\ {S}_{2}^{T} & {S}_{4}^{T} & {R}_{2}^{T} & {R}_{3}\end{matrix} ] , \\ {P}^{- 1} = \tilde{P} = [ \begin{matrix}\tilde{Q} & \tilde{S} \\ {\tilde{S}}^{T} & \tilde{R}\end{matrix} ] = [ \begin{matrix}{\tilde{Q}}_{1} & {\tilde{Q}}_{2} & {\tilde{S}}_{1} & {\tilde{S}}_{2} \\ {\tilde{Q}}_{2}^{T} & {\tilde{Q}}_{3} & {\tilde{S}}_{3} & {\tilde{S}}_{4} \\ {\tilde{S}}_{1}^{T} & {\tilde{S}}_{3}^{T} & {\tilde{R}}_{1} & {\tilde{R}}_{2} \\ {\tilde{S}}_{2}^{T} & {\tilde{S}}_{4}^{T} & {\tilde{R}}_{2}^{T} & {\tilde{R}}_{3}\end{matrix} ] \qquad ( 14 )$$

wherein Q₁, Q₂ and Q₃ respectively represent sub-block matrices of Q; S₁, S₂, S₃ and S₄ respectively represent sub-block matrices of S; R₁, R₂ and R₃ respectively represent sub-block matrices of R; \tilde{Q}, \tilde{S} and \tilde{R} respectively represent sub-block matrices of \tilde{P}; \tilde{Q}₁, \tilde{Q}₂ and \tilde{Q}₃ respectively represent sub-block matrices of \tilde{Q}; \tilde{S}₁, \tilde{S}₂, \tilde{S}₃ and \tilde{S}₄ respectively represent sub-block matrices of \tilde{S}; \tilde{R}₁, \tilde{R}₂ and \tilde{R}₃ respectively represent sub-block matrices of \tilde{R};

constructing the following LMIs, and combining to solve corresponding matrix solutions L, J, Q₃, R₃, S₄, \tilde{Q}₃, \tilde{R}₃ and \tilde{S}₄:

$$\begin{matrix}{{N}_{L}^{T} [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ]}^{T} [ \begin{matrix}0 & 0 & 0 & L & 0 & 0 \\ 0 & {Q}_{3} & 0 & 0 & {S}_{4} & 0 \\ 0 & 0 & - γ I & 0 & 0 & 0 \\ L & 0 & 0 & 0 & 0 & 0 \\ 0 & {S}_{4}^{T} & 0 & 0 & {R}_{3} & 0 \\ 0 & 0 & 0 & 0 & 0 & {γ}^{- 1} I\end{matrix} ] [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ] {N}_{L} < 0 & ( 15 ) \\ {{N}_{J}^{T} [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ]}^{T} [ \begin{matrix}0 & 0 & 0 & J & 0 & 0 \\ 0 & {\tilde{Q}}_{3} & 0 & 0 & {\tilde{S}}_{4} & 0 \\ 0 & 0 & - {γ}^{- 1} I & 0 & 0 & 0 \\ J & 0 & 0 & 0 & 0 & 0 \\ 0 & {\tilde{S}}_{4}^{T} & 0 & 0 & {\tilde{R}}_{3} & 0 \\ 0 & 0 & 0 & 0 & 0 & γ I\end{matrix} ] [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ] {N}_{J} > 0 & ( 16 ) \\ [ \begin{matrix}J & I \\ I & L\end{matrix} ] > 0 & ( 17 ) \\ R > 0 , Q = - R , S + {S}^{T} = 0 & ( 18 )\end{matrix}$$

wherein N_{L} and N_{J} are respectively the bases of the nuclear spaces of [C₃ D₃₁ D₃₂] and [0 D₁₃^{T} D₂₃^{T}];

step 3.5: further, solving X in the formula (17) according to a solving result of the step 3.4;

$$X [ \begin{matrix}J & I \\ {W}^{T} & 0\end{matrix} ] = [ \begin{matrix}I & L \\ 0 & {V}^{T}\end{matrix} ] \qquad ( 17 )$$

solving P according to P\tilde{P}=I;

step 3.6: solving the following LMIs to obtain an estimation matrix Γ of the fault estimator:

$$Ψ + {\overline{P}}^{T} {Γ}^{T} {\overline{Q}}_{X} + {\overline{Q}}_{X}^{T} Γ \overline{P} < 0 \\ wherein Ψ = [ \begin{matrix}{A}_{0}^{T} X + {XA}_{0} & {XB}_{01} + {C}_{01}^{T} {S}^{T} & {XB}_{02} & {C}_{01}^{T} & {C}_{02}^{T} \\ {SC}_{01} + {B}_{01}^{T} {X}^{T} & Q + {D}_{01}^{T} {S}^{T} + {SD}_{01} & {SD}_{02} & {D}_{01}^{T} & {D}_{03}^{T} \\ {B}_{02}^{T} {X}^{T} & {D}_{02}^{T} {S}^{T} & - γ I & {D}_{02}^{T} & {D}_{04}^{T} \\ {C}_{1} & {D}_{01} & {D}_{02} & - \tilde{R} & 0 \\ {C}_{02} & {D}_{03} & {D}_{4} & 0 & - γ I\end{matrix} ] \\ \overline{P} = [ \begin{matrix}{T}_{2} & {T}_{3} & {T}_{4} & 0 & 0\end{matrix} ] , {\overline{Q}}_{X} = [ \begin{matrix}{T}_{1}^{T} X & {T}_{5}^{T} {S}^{T} & 0 & {T}_{5}^{T} & {T}_{6}^{T}\end{matrix} ] \qquad ( 19 )$$

further, computing a coefficient matrix of the fault estimator:

$$[ \begin{matrix}{A}_{E} ( λ ) & {B}_{E} ( λ ) \\ {C}_{E} ( λ ) & {D}_{E} ( λ )\end{matrix} ] = [ \begin{matrix}{A}_{e} & {B}_{e 1} \\ {C}_{e 1} & {D}_{e 11}\end{matrix} ] + [ \begin{matrix}{B}_{e 2} \\ {D}_{e 12}\end{matrix} ] {Λ ( I - {D}_{e 22} Λ )}^{- 1} [ \begin{matrix}{C}_{e 2} & {D}_{e 21}\end{matrix} ] \qquad ( 20 )$$

step 4: designing an active fault tolerant controller of a turbofan engine based on a virtual actuator according to a fault estimation result: and without redesigning the controller, making the control system stable and obtaining a control effect similar to that of the system without fault;

step 4.1: considering the system with fault of the turbofan engine; and when the sensor and actuator faults exist, designing the virtual actuator based on a reconfiguration principle, with a state space model representation of a reconfigured system as follows:

$$\{ \begin{matrix}[ \begin{matrix}{\dot{\overline{x}}}_{f} \\ {x}_{Δ}\end{matrix} ] = [ \begin{matrix}A ( λ ) & {B}_{2 f} ( λ ) {C}_{Δ} ( λ ) \\ 0 & {A}_{Δ} λ\end{matrix} ] [ \begin{matrix}{\overline{x}}_{f} \\ {x}_{Δ}\end{matrix} ] + [ \begin{matrix}{\overline{B}}_{1} \\ 0\end{matrix} ] \overline{w} + [ \begin{matrix}{\overline{B}}_{2 f} ( λ ) {D}_{Δ} ( λ ) \\ {B}_{Δ} ( λ )\end{matrix} ] {u}_{c} \\ {z}_{re} = [ \begin{matrix}{\overline{C}}_{1} & 0\end{matrix} ] [ \begin{matrix}{\overline{x}}_{f} \\ {x}_{Δ}\end{matrix} ] + {\overline{D}}_{11} \overline{w} \\ {x}_{c} = [ \begin{matrix}I & I\end{matrix} ] [ \begin{matrix}{\overline{x}}_{f} \\ {x}_{Δ}\end{matrix} ]\end{matrix} \\ wherein {\overline{x}}_{f} = [ \begin{matrix}{x}_{f} \\ {x}_{ef}\end{matrix} ] ; {x}_{ef} = {\int }_{0}^{t} {e}_{f} ( s ) ds = {\int }_{0}^{t} ( {y}_{f} ( s ) - {y}_{r} ( s ) ) ds ; \qquad ( 21 )$$

x_{Δ} is a state variable of the virtual actuator;

$${B}_{2 f} = [ \begin{matrix}{B}_{f} ( λ ) \\ 0\end{matrix} ] ; {A}_{Δ} ( λ ) = \overline{A} ( λ ) - {\overline{B}}_{2 f} ( λ ) M ( λ ) ;$$

$${B}_{Δ} ( λ ) = {\overline{B}}_{2} ( λ ) - {\overline{B}}_{2 f} ( λ ) N ( λ ) ; \overline{w} = [ \begin{matrix}d \\ {y}_{r}\end{matrix} ] ; {C}_{Δ} ( λ ) = M ( λ ) ;$$

$${D}_{Δ} ( λ ) = N ( λ ) ; {\overline{C}}_{1} = [ \begin{matrix}C & 0 \\ 0 & I\end{matrix} ] ; {\overline{D}}_{11} = [ \begin{matrix}G & - I \\ 0 & 0\end{matrix} ] ; {x}_{c} = {x}_{Δ} + {\overline{x}}_{f} ; {z}_{re}$$

is a controlled output of the reconfigured system; M(λ) and N(λ) are to-be-solved matrices in an active fault tolerant control law;

solving positive definite matrices Xᵥ, Y₁ and Y₂ according to LMIs combined by (22)-(24);

$$\begin{matrix}{\overline{A}}_{i} {X}_{v} - {\overline{B}}_{2 {f}_{i}} {Y}_{i} + {X}_{v} {\overline{A}}_{i}^{T} - {Y}_{i}^{T} {\overline{B}}_{2 {f}_{i}}^{T} + 2 ρ {X}_{v} < 0 & ( 22 ) \\ [ \begin{matrix}- {rX}_{v} & {qX}_{c} + {\overline{A}}_{i} {X}_{v} - {\overline{B}}_{2 {f}_{i}} {Y}_{i} \\ * & - {rX}_{v}\end{matrix} ] < 0 & ( 23 ) \\ [ \begin{matrix}sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} ) & cos ( θ ) ( \begin{matrix}{\overline{A}}_{i} {X}_{v} - {\overline{B}}_{2 {f}_{i}} {Y}_{i} - \\ {X}_{v} {\overline{A}}_{i}^{T} - {Y}_{i}^{T} {\overline{B}}_{2 {f}_{i}}^{T}\end{matrix} ) \\ cos ( θ ) ( \begin{matrix}{X}_{v}^{T} {\overline{A}}_{i}^{T} - {Y}_{i} {\overline{B}}_{2 {f}_{i}}^{T} - \\ {\overline{A}}_{i} {X}_{v}^{T} - {\overline{B}}_{2 {f}_{i}} {Y}_{i}\end{matrix} ) & sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} )\end{matrix} ] < 0 & ( 24 )\end{matrix}$$

wherein i=1, 2; ρ is a minimum decay rate of an LMI region; r is a radius of the LMI region; q is a center of a circle; θ is an intersection angle of close loop poles and a transverse axis in the LMI region;

step 4.2: obtaining a matrix Mᵢ according to Yᵢ=MᵢXᵥ;

step 4.3: computing

$$N ( λ ) = {\sum }_{i = 1}^{2} {α}_{i} {N}_{i} = {\sum }_{i = 1}^{2} {α}_{i} {\overline{B}}_{2 {f}_{i}}^{+} {\overline{B}}_{{2}_{i}} .$$

wherein B̅_{2f}_{ᵢ}⁺ represents pseudo inverse of B̅_{2f}_{ᵢ};

step 4.4: computing a system matrix;

A_{Δ}(λ)=Ā(λ)−B̅_{2f}(λ)M(λ), B_{Δ}(λ)=B̅₂(λ)−B̅_{2f}(λ)

C_{Δ}(λ)=M(λ), D_{Δ}(λ)=N(λ)

constructing a state space equation and a control law of the active fault tolerant controller:

$$\{ \begin{matrix}{\dot{x}}_{Δ} = {A}_{Δ} ( λ ) {x}_{Δ} + {B}_{Δ} ( λ ) {u}_{c} \\ {u}_{f} = {C}_{Δ} ( λ ) {x}_{Δ} + {D}_{Δ} ( λ ) {u}_{c} - {\overline{B}}_{2 f}^{- 1} \overline{F} ( λ ) \hat{f}\end{matrix} . \qquad ( 25 )$$

The present invention has the beneficial effects: through the active fault tolerant controller of the turbofan engine control system designed by the method of the present invention, when the turbofan engine control system has actuator and sensor faults at the same time, without redesigning the controller, the control system is stable and a speed tracking effect similar to that of the system without fault is obtained through the designed reconfiguration controller.

### DESCRIPTION OF DRAWINGS

FIG. 1 is a design flow chart of an active fault tolerant controller of a sensor and an actuator of a turbofan engine control system;

FIG. 2 is a block diagram of an LPV gain scheduling robust tracking controller of a turbofan engine;

FIG. 3(a) shows turbofan engine LPV gain scheduling robust tracking control simulation results when relative conversion speed of high pressure rotors is 88%;

FIG. 3(b) shows turbofan engine LPV gain scheduling robust tracking control simulation results when relative conversion speed of high pressure rotors is 94%;

FIG. 4 is a block diagram of a fault estimator of a turbofan engine;

FIG. 5(a) shows fault estimation results of a sensor of a turbofan engine;

FIG. 5(b) shows fault estimation results of an actuator of a turbofan engine;

FIG. 6 is a block diagram of an active fault tolerant controller of a sensor and an actuator of a turbofan engine control system;

FIG. 7(a) shows output of a system with fault when the relative conversion speed of high pressure rotors is 90%;

FIG. 7(b) shows output of a system with fault when the relative conversion speed of high pressure rotors is 94%;

FIG. 8(a) shows normal output results of a turbofan engine control system when the relative conversion speed of high pressure rotors is 90%;

FIG. 8(b) shows active fault tolerant control results of a turbofan engine control system when the relative conversion speed of high pressure rotors is 90%;

FIG. 9(a) shows normal output results of a turbofan engine control system when the relative conversion speed of high pressure rotors is 94%; and

FIG. 9(b) shows active fault tolerant control results of a turbofan engine control system when the relative conversion speed of high pressure rotors is 94%.

### DETAILED DESCRIPTION

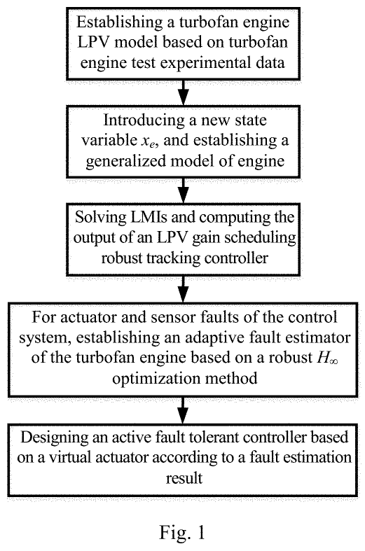

The present invention is further described below in combination with the drawings. The research object of the present invention is the turbofan engine after the sensor and actuator faults of the control system. The design method is shown in a flow chart of FIG. 1. Detailed design steps are as follows.

Step 1: establishing a turbofan engine LPV model based on turbofan engine test experimental data:

$$\begin{matrix} \{ \begin{matrix}[ \begin{matrix}{\dot{x}}_{1} \\ {\dot{x}}_{2}\end{matrix} ] = [ \begin{matrix}{a}_{11} ( λ ) & {a}_{12} ( λ ) \\ {a}_{21} ( λ ) & {a}_{22} ( λ )\end{matrix} ] [ \begin{matrix}{x}_{1} \\ {x}_{2}\end{matrix} ] + [ \begin{matrix}{b}_{1} ( λ ) \\ {b}_{2} ( λ )\end{matrix} ] u + [ \begin{matrix}0.1 \\ 0\end{matrix} ] d \\ y [ \begin{matrix}0 & 1\end{matrix} ] [ \begin{matrix}{x}_{1} \\ {x}_{2}\end{matrix} ] + 0.2 d\end{matrix} & \\ wherein & \\ [ \begin{matrix}{a}_{11} ( λ ) & {a}_{12} ( λ ) \\ {a}_{21} ( λ ) & {a}_{22} ( λ )\end{matrix} ] = [ \begin{matrix}- 2.6748 & 0.6877 \\ 1.0704 & - 4.4672\end{matrix} ] + λ [ \begin{matrix}0.5199 & - 2.4061 \\ 0.1049 & - 0.8365\end{matrix} ] & ( 26 ) \\ [ \begin{matrix}{b}_{1} ( λ ) \\ {b}_{2} ( λ )\end{matrix} ] = [ \begin{matrix}0.0033 \\ 0.0012\end{matrix} ] + λ [ \begin{matrix}- 0.0004 \\ - 0.0001\end{matrix} ] & ( 27 )\end{matrix}$$

a scheduling parameter λ is a normalized relative conversion speed of high pressure rotors of the turbofan engine: −1≤λ≤1; thus, a time varying parameter k forms a parametric polyhedron with −1 and 1 as vertexes, and the disturbance d takes Gaussian white noise with a standard deviation of 0.0001.

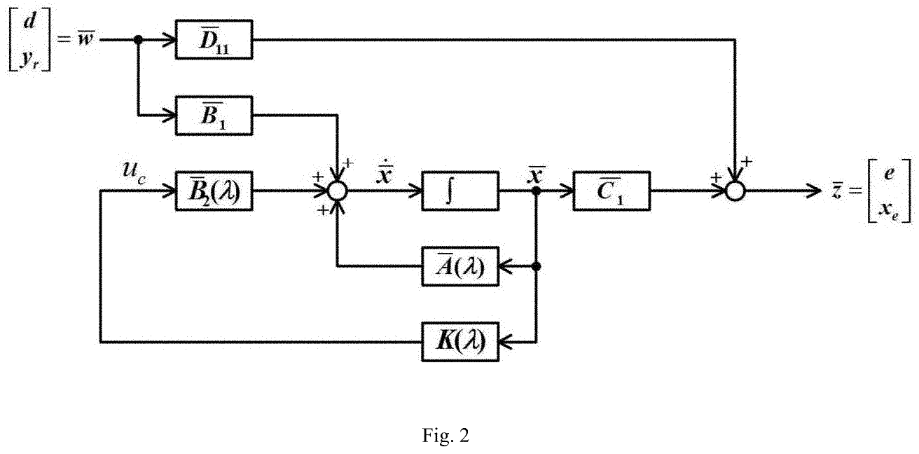

Step 2: as shown in FIG. 2, designing a LPV gain scheduling robust tracking controller for the turbofan engine LPV model with disturbance.

Setting γ=2 and solving LMI (4) to obtain the following corresponding matrix solutions X and Vᵢ (i=1, 2).

$$X = [ \begin{matrix}10.3036 & 1.4883 & - 1.7799 \\ 1.4883 & 1.5432 & - 0.9087 \\ - 1.7799 & - 0.9087 & 0.8419\end{matrix} ]$$

$${V}_{1} = [ \begin{matrix}5589 & - 3460 & - 946\end{matrix} ]$$

$${V}_{2} = [ \begin{matrix}5894 & - 1975 & - 2096\end{matrix} ]$$

Obtaining the gain K(k) of the speed tracking controller in combination with the formula (5), and

$${α}_{1} ( λ ) = \frac{1 - λ}{1 - ( - 1 )} , {α}_{2} ( λ ) = \frac{λ - ( - 1 )}{1 - ( - 1 )}$$

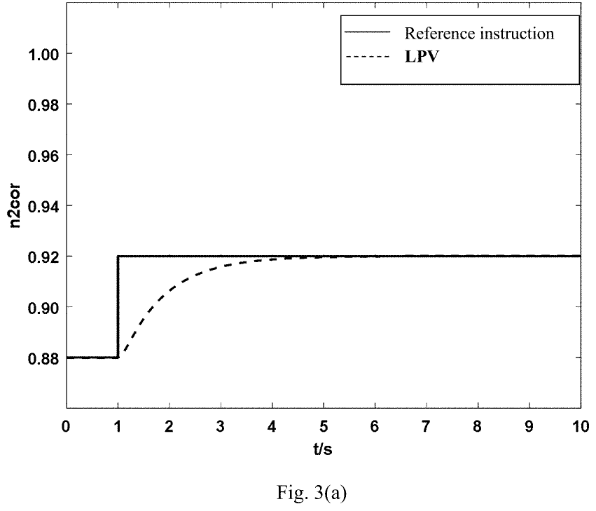

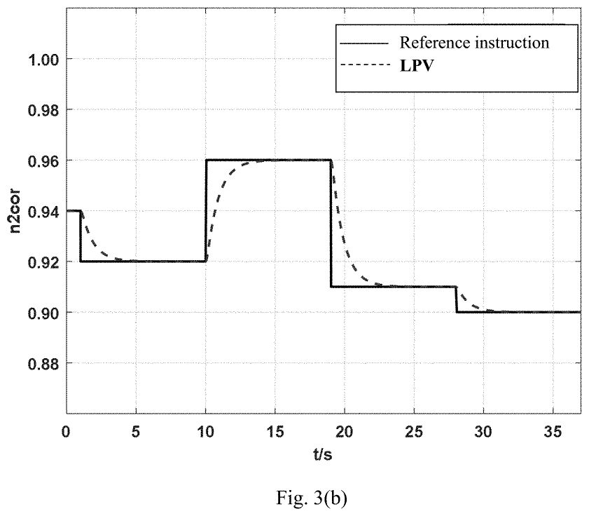

Thus, the gain of the speed tracking controller can be changed with the change of the time varying parameter λ and has scheduling characteristics. FIG. 3 respectively shows turbofan engine LPV gain scheduling robust tracking control simulation results when the relative conversion speeds of high pressure rotors are respectively 90% and 94%. It can be seen from the simulation results that, regardless of the parameters at the vertex or the parameters at non-vertex, the designed LPV speed tracking controller can ensure that the output responds quickly and tracks a reference instruction. Therefore, the controller has good control performance within all time varying parameters, can stably and quickly realize tracking and has good robustness and stability.

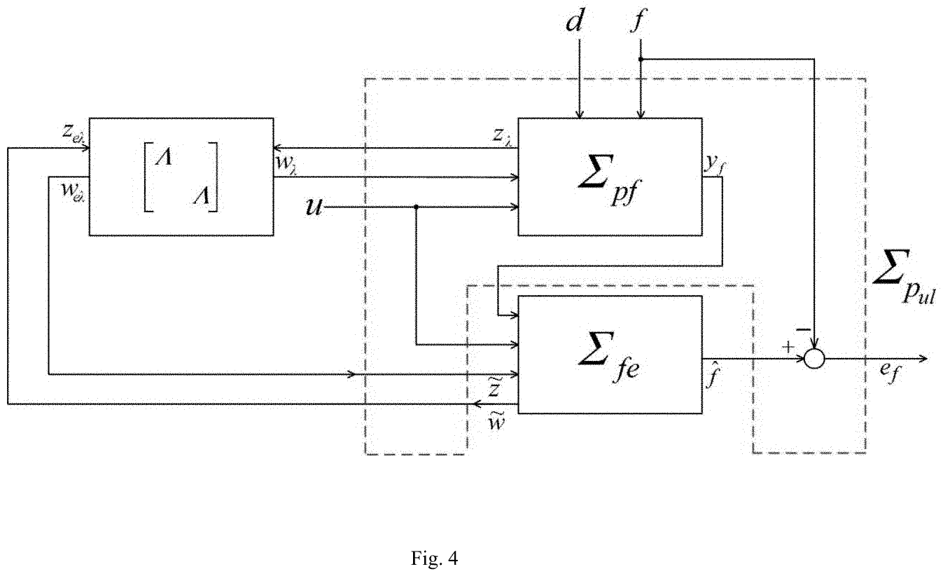

Step 3: establishing an adaptive fault estimator of the turbofan engine, as shown in FIG. 4, to realize fault estimation of a sensor and an actuator: considering that the turbofan engine control system has the actuator and sensor faults, as shown in formula (28):

$$\{ \begin{matrix}[ \begin{matrix}{\dot{x}}_{1} \\ {\dot{x}}_{2}\end{matrix} ] = [ \begin{matrix}{a}_{11} ( λ ) & {a}_{12} ( λ ) \\ {a}_{21} ( λ ) & {a}_{22} ( λ )\end{matrix} ] [ \begin{matrix}{x}_{1} \\ {x}_{2}\end{matrix} ] + [ \begin{matrix}{b}_{1} ( λ ) \\ {b}_{2} ( λ )\end{matrix} ] u + [ \begin{matrix}0.1 \\ 0\end{matrix} ] d + [ \begin{matrix}{f}_{1} ( λ ) \\ 0\end{matrix} ] f \\ y = [ \begin{matrix}0 & 1\end{matrix} ] [ \begin{matrix}{x}_{1} \\ {x}_{2}\end{matrix} ] + 0.2 d + [ \begin{matrix}0 \\ h ( λ )\end{matrix} ] f\end{matrix} \qquad ( 28 )$$

wherein f₁(λ)=0.1+0.01λ, −1≤λ≤1, h(λ)=0.5+0.02λ, −1≤λ≤1, and the disturbance takes Gaussian white noise with a standard deviation of 0.0001. The time varying parameter λ is real-time measurable, and the change thereof is supposed as follows

$$λ ( t ) = \{ \begin{matrix}0 , & 0 \leq t < 5 s \\ - 0.3333 , & 5 s \leq t < 10 s \\ 0.3333 , & 10 s \leq t < 15 s \\ - 0.5 , & 15 s \leq t < 20 s \\ - 0.6667 , & 20 s \leq t < 25 s\end{matrix}$$

A multiplicative actuator fault is expr as

$$[ \begin{matrix}{b}_{1 f} ( λ ) \\ {b}_{2 f} ( λ )\end{matrix} ] = [ \begin{matrix}0.1 {b}_{1} ( λ ) \\ 0.1 {b}_{2} ( λ )\end{matrix} ]$$

A time varying part and a time invariant part in the formula (28) are separated and rewritten into the following form

$$\{ \begin{matrix}[ \begin{matrix}{\dot{x}}_{f} \\ {z}_{λ} \\ {y}_{f}\end{matrix} ] = [ \begin{matrix}A & {B}_{f 1} & {B}_{f 2} \\ {C}_{f 1} & {D}_{f 11} & {D}_{f 12} \\ {C}_{f 2} & {D}_{f 21} & {D}_{f 22}\end{matrix} ] [ \begin{matrix}{x}_{f} \\ {w}_{λ} \\ w\end{matrix} ] \\ {w}_{λ} = Λ {z}_{λ}\end{matrix}$$

wherein external input is w=[u^{T} d^{T} f^{T}]^{T}; z_{λ}, w_{λ}∈R^{r} are respectively input and output variables of a r-dimensional time varying subsystem Λ=λI in the formula (6): B_{f1}∈R^{n×r}, B_{f2}∈R^{n×(m+q+l)}, C_{f1}∈R^{r×n}, C_{f2}∈R^{p×n}, D_{f11}∈R^{r×r} D₁₂∈R^{r×(m+q+l)}, D_{f21}∈∈R^{p×r} and D_{f22}∈R^{p×(m+q+l)} are system state space matrices.

A fault estimator state space expression is constructed as follows

$$\{ \begin{matrix}[ \begin{matrix}{\dot{x}}_{e} \\ \hat{f} \\ {z}_{e λ}\end{matrix} ] = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] [ \begin{matrix}{x}_{e} \\ {u}_{e} \\ {w}_{e λ}\end{matrix} ] \\ {w}_{e λ} = Λ {z}_{e λ}\end{matrix}$$

wherein xₑ∈R^{k}, uₑ=[u^{T} Y_{f}^{T}]^{T}∈R^{(p+m)} and \hat{f}∈R^{t} respectively represent a state variable, a control input and a fault estimation output of the fault estimator; z_{eλ}∈R^{r} and w_{eλ}∈R^{r} respectively represent an input and an output of the time varying part of the fault estimator; Aₑ∈R^{k×k}, Bₑ₁∈R^{k×(m+p)}, Bₑ₂∈R^{k×r}, Cₑ₁∈R^{l×k}, Cₑ₂∈R^{r×k}, Dₑ₁₁∈R^{l×(p+m)}, Dₑ₁₂∈R^{l×r}, Dₑ₂₁∈R^{r×(p+m)} and Dₑ₂₂∈R^{r×r} are fault estimator coefficient matrices to be designed.

A state space joint representation of the system with fault of the turbofan engine and the fault estimator is constructed:

$$\{ \begin{matrix}[ \begin{matrix}{\dot{x}}_{f} \\ \frac{{\dot{x}}_{e}}{{z}_{e λ}} \\ \frac{{z}_{λ}}{{e}_{f}}\end{matrix} ] = [ \begin{matrix}A & {B}_{1} & {B}_{2} \\ {C}_{1} & {D}_{11} & {D}_{12} \\ {C}_{2} & {D}_{21} & {D}_{22}\end{matrix} ] [ \begin{matrix}{x}_{f} \\ \frac{{x}_{e}}{{w}_{e λ}} \\ \frac{{w}_{λ}}{w}\end{matrix} ] \\ [ \begin{matrix}{w}_{λ} \\ {w}_{e λ}\end{matrix} ] = [ \begin{matrix}Λ & 0 \\ 0 & Λ\end{matrix} ] [ \begin{matrix}{z}_{λ} \\ {z}_{e λ}\end{matrix} ]\end{matrix}$$

wherein a fault estimate error is e_{f}=\hat{f}−f,

$$\begin{matrix}[ \begin{matrix}{A}^{\_ } & {\overline{B} }_{1} & {{B}^{\_ }}_{2} \\ {\overline{C}}_{1} & {{D}^{\_ }}_{11} & {{D}^{\_ }}_{12} \\ {\overline{C}}_{2} & {{D}^{\_ }}_{21} & {{D}^{\_ }}_{22}\end{matrix} ] = [ \begin{matrix}{A}_{0} & {B}_{01} & {B}_{02} \\ {C}_{01} & {D}_{01} & {D}_{02} \\ {C}_{02} & {D}_{03} & {D}_{04}\end{matrix} ] + [ \begin{matrix}{T}_{1} \\ {T}_{5} \\ {T}_{6}\end{matrix} ] Γ [ \begin{matrix}{T}_{2} & {T}_{3} & {T}_{4}\end{matrix} ] \\ {A}_{0} = [ \begin{matrix}A & 0 \\ 0 & 0\end{matrix} ] , {B}_{01} = [ \begin{matrix}0 & {B}_{f 1} \\ 0 & 0\end{matrix} ] , {B}_{02} = [ \begin{matrix}{B}_{f 2} \\ 0\end{matrix} ] & ( 10 ) \\ {C}_{01} = [ \begin{matrix}0 & 0 \\ {C}_{f 1} & 0\end{matrix} ] , {D}_{01} = [ \begin{matrix}0 & 0 \\ 0 & {D}_{f 11}\end{matrix} ] , {D}_{02} = [ \begin{matrix}0 \\ {D}_{f 12}\end{matrix} ] \\ {C}_{02} = [ \begin{matrix}0 & 0\end{matrix} ] , {D}_{03} = [ \begin{matrix}0 & 0\end{matrix} ] , {D}_{04} = {D}_{22} & ( 11 ) \\ {T}_{1} = [ \begin{matrix}0 & 0 & 0 \\ I & 0 & 0\end{matrix} ] , {T}_{2} = [ \begin{matrix}0 & I \\ {C}_{3} & 0 \\ 0 & 0\end{matrix} ] , {T}_{3} = [ \begin{matrix}0 & 0 \\ 0 & {D}_{31} \\ I & 0\end{matrix} ] \\ {T}_{4} = [ \begin{matrix}0 \\ {D}_{32} \\ 0\end{matrix} ] , {T}_{5} = [ \begin{matrix}0 & 0 & I \\ 0 & {D}_{13} & 0\end{matrix} ] , {T}_{6} = [ \begin{matrix}0 & {D}_{23} & 0\end{matrix} ] & ( 12 ) \\ Γ = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] {C}_{3} = [ \begin{matrix}0 \\ {C}_{f 2}\end{matrix} ] , {D}_{22} = [ \begin{matrix}0 & - I \\ 0 & 0\end{matrix} ] , \\ {D}_{23} = [ \begin{matrix}I \\ 0\end{matrix} ] , {D}_{31} = [ \begin{matrix}0 \\ {D}_{f 21}\end{matrix} ] , {D}_{32} = [ \begin{matrix}I & 0 & 0 \\ & {D}_{f 22} & \end{matrix} ] & ( 13 )\end{matrix}$$

and Γ are estimation matrices of the fault estimator.

Setting

$$X = [ \begin{matrix}L & V \\ {V}^{T} & Y\end{matrix} ] , {X}^{- 1} = [ \begin{matrix}J & W \\ {W}^{T} & Z\end{matrix} ]$$

wherein L, V and Y respectively represent sub-block matrices of X; and J, W and Z respectively represent sub-block matrices of X.

A matrix P and its inverse matrix \tilde{P} are constructed:

$$P = [ \begin{matrix}Q & S \\ {S}^{T} & R\end{matrix} ] = [ \begin{matrix}{Q}_{1} & {Q}_{2} & {S}_{1} & {S}_{2} \\ {Q}_{2}^{T} & {Q}_{3} & {S}_{3} & {S}_{4} \\ {S}_{1}^{T} & {S}_{3}^{T} & {R}_{1} & {R}_{2} \\ {S}_{2}^{T} & {S}_{4}^{T} & {R}_{2}^{T} & {R}_{3}\end{matrix} ] , \\ {P}^{- 1} = \tilde{P} = [ \begin{matrix}\tilde{Q} & \tilde{S} \\ {\tilde{S}}^{T} & \tilde{R}\end{matrix} ] = [ \begin{matrix}{\tilde{Q}}_{1} & {\tilde{Q}}_{2} & {\tilde{S}}_{1} & {\tilde{S}}_{2} \\ {\tilde{Q}}_{2}^{T} & {\tilde{Q}}_{3} & {\tilde{S}}_{3} & {\tilde{S}}_{4} \\ {\tilde{S}}_{1}^{T} & {\tilde{S}}_{3}^{T} & {\tilde{R}}_{1} & {\tilde{R}}_{2} \\ {\tilde{S}}_{2}^{T} & {\tilde{S}}_{4}^{T} & {\tilde{R}}_{2}^{T} & {\tilde{R}}_{3}\end{matrix} ]$$

wherein Q₁, Q₂ and Q₃ respectively represent sub-block matrices of Q; S₁, S₂, S₃ and S₄ respectively represent sub-block matrices of S; R₁, R₂ and R₃ respectively represent sub-block matrices of R; \tilde{Q}, \tilde{S} and \tilde{R} respectively represent sub-block matrices of \tilde{P}; \tilde{Q}₁, \tilde{Q}₂ and \tilde{Q}₃ respectively represent sub-block matrices of \tilde{Q}; \tilde{S}₁, \tilde{S}₂, \tilde{S}₃ and \tilde{S}₄ respectively represent sub-block matrices of \tilde{S}; \tilde{R}₁, \tilde{R}₂ and \tilde{R}₃ respectively represent sub-block matrices of \tilde{R}.

The following LMIs are constructed, and combined to solve corresponding matrix solutions L, J, Q₃, R₃, S₄, \tilde{Q}₃, \tilde{R}₃ and \tilde{S}₄:

$${{N}_{L}^{T} [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ]}^{T} [ \begin{matrix}0 & 0 & 0 & L & 0 & 0 \\ 0 & {Q}_{3} & 0 & 0 & {S}_{4} & 0 \\ 0 & 0 & - γ I & 0 & 0 & 0 \\ L & 0 & 0 & 0 & 0 & 0 \\ 0 & {S}_{4}^{T} & 0 & 0 & {R}_{3} & 0 \\ 0 & 0 & 0 & 0 & 0 & {γ}^{- 1} I\end{matrix} ] [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ] {N}_{L} < 0 \\ {{N}_{J}^{T} [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ]}^{T} [ \begin{matrix}0 & 0 & 0 & J & 0 & 0 \\ 0 & {\tilde{Q}}_{3} & 0 & 0 & {\tilde{S}}_{4} & 0 \\ 0 & 0 & - {γ}^{- 1} I & 0 & 0 & 0 \\ J & 0 & 0 & 0 & 0 & 0 \\ 0 & {\tilde{S}}_{4}^{T} & 0 & 0 & {\tilde{R}}_{3} & 0 \\ 0 & 0 & 0 & 0 & 0 & γ I\end{matrix} ] [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ] {N}_{L} < 0 \\ [ \begin{matrix}J & I \\ I & L\end{matrix} ] > 0 , R > 0 , Q = - R , S + {S}^{T} = 0$$

wherein N_{L} and N_{J} are respectively the bases of the nuclear spaces of [C₃ D₃₁ D₃₂] and [0 D₁₃^{T} D₂₃^{T}].

Further, X is solved:

$$X [ \begin{matrix}J & I \\ {W}^{T} & 0\end{matrix} ] = [ \begin{matrix}I & L \\ 0 & {V}^{T}\end{matrix} ]$$

P is solved according to P\tilde{P}=1.

The following LMIs are solved to obtain an estimation matrix Γ of the fault estimator:

Ψ+P̅^{T}Γ^{T}Q̅_{X}+Q̅_{X}^{T}ΓP̅<0

wherein

$$Ψ = [ \begin{matrix}{A}_{0}^{T} X + {XA}_{0} & {XB}_{01} + {C}_{01}^{T} {S}^{T} & {XB}_{02} & {C}_{01}^{T} & {C}_{02}^{T} \\ {SC}_{01} + {B}_{01}^{T} {X}^{T} & Q + {D}_{01}^{T} {S}^{T} + {SD}_{01} & {SD}_{02} & {D}_{01}^{T} & {D}_{03}^{T} \\ {B}_{02}^{T} {X}^{T} & {D}_{02}^{T} {S}^{T} & - γ I & {D}_{02}^{T} & {D}_{04}^{T} \\ {C}_{01} & {D}_{01} & {D}_{02} & - \tilde{R} & 0 \\ {C}_{02} & {D}_{03} & {D}_{04} & 0 & - γ I\end{matrix} ]$$

$$\overline{P} = [ \begin{matrix}{T}_{2} & {T}_{3} & {T}_{4} & 0 & 0\end{matrix} ] , {\overline{Q}}_{X} = [ \begin{matrix}{T}_{1}^{T} X & {T}_{5}^{T} {S}^{T} & 0 & {T}_{5}^{T} & {T}_{6}^{T}\end{matrix} ]$$

Further, a coefficient matrix of the fault estimator is computed.

$$[ \begin{matrix}{A}_{E} ( λ ) & {B}_{E} ( λ ) \\ {C}_{E} ( λ ) & {D}_{E} ( λ )\end{matrix} ] = [ \begin{matrix}{A}_{e} & {B}_{e 1} \\ {C}_{e 1} & {D}_{e 11}\end{matrix} ] + [ \begin{matrix}{B}_{e 2} \\ {D}_{e 12}\end{matrix} ] {Λ ( I - {D}_{e 22} Λ )}^{- 1} [ \begin{matrix}{C}_{e 2} & {D}_{e 21}\end{matrix} ]$$

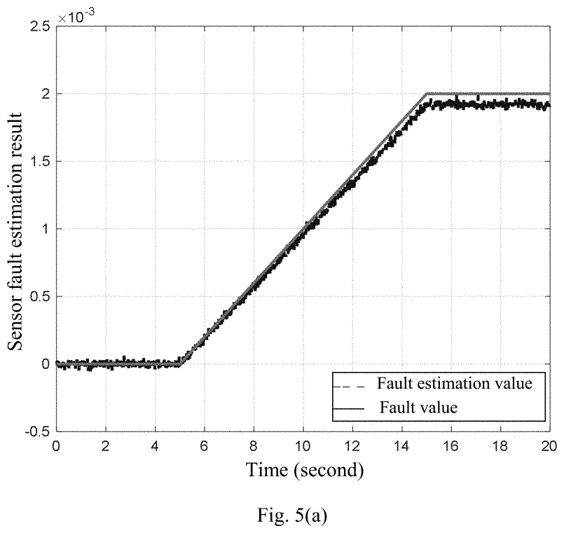

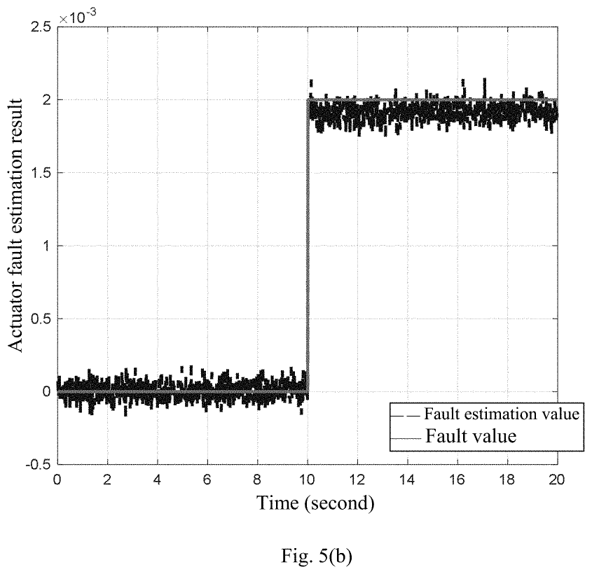

FIG. 5 respectively shows estimation results of the fault estimator when the sensor and the actuator of the control system have sudden faults. It can be seen from the simulation results that, the LPV fault estimator can adaptively adjust the parameters, adapt to current system dynamics, quickly detect the faults, and accurately reconfigure fault signals.

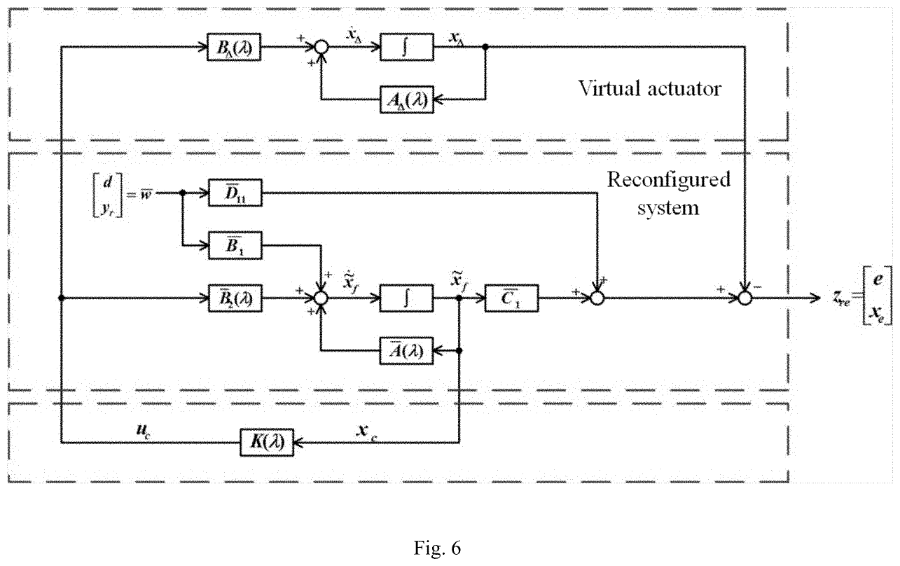

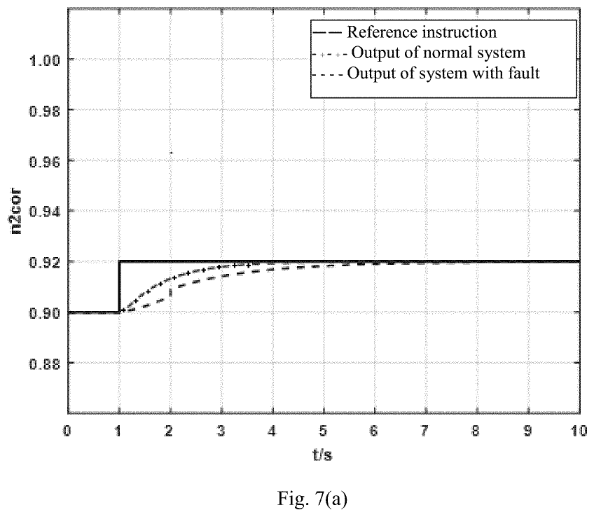

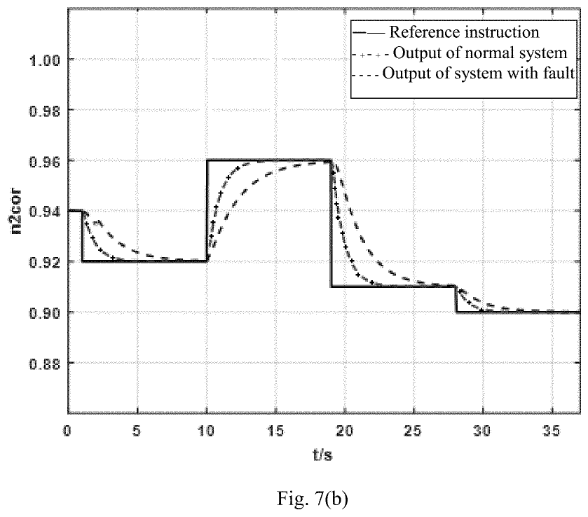

Step 4: designing an active fault tolerant controller of a turbofan engine based on a virtual actuator according to a fault estimation result, as shown in FIG. 6. Considering the system (28) with fault of the turbofan engine, FIG. 7 shows the output of the system with fault when the relative conversion speeds of high pressure rotors are respectively 90% and 94%. It can be seen that under fault states, the output of the system is significantly different from that of the system without fault. Positive definite matrices Xᵥ, Y₁ and Y₂ are solved according to LMIs combined by (22)-(24).

$${\overline{A}}_{t} {X}_{v} - {\overline{B}}_{2 {f}_{i}} {Y}_{i} + {X}_{v} {\overline{A}}_{i}^{T} - {Y}_{i}^{T} {\overline{B}}_{2 {f}_{i}}^{T} + 2 ρ {X}_{v} < 0 \\ [ \begin{matrix}- {rX}_{v} & {qX}_{v} + {\overline{A}}_{i} {X}_{v} - {\overline{B}}_{2 {f}_{i}} {Y}_{i} \\ * & - {rX}_{v}\end{matrix} ] \\ [ \begin{matrix}sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} ) & cos ( θ ) ( \begin{matrix}{\overline{A}}_{i} {X}_{v} - {\overline{B}}_{2 {f}_{i}} - \\ {X}_{v} {\overline{A}}_{i}^{T} - {Y}_{i}^{T} {\overline{B}}_{2 {f}_{i}}^{T}\end{matrix} ) \\ cos ( θ ) ( \begin{matrix}{X}_{v}^{T} {\overline{A}}_{i}^{T} - {Y}_{i}^{T} {\overline{B}}_{2 \overline{{f}_{i}}}^{T} - \\ {\overline{A}}_{i} {X}_{v}^{T} - {\overline{B}}_{2 {f}_{i}} {Y}_{i}\end{matrix} ) & sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} )\end{matrix} ]$$

wherein i=1, 2, ρ=10, r=−4.5, q=15 and θ=π/6.

A matrix Mᵢ (i=1, 2) is obtained according to Y₁=MᵢXᵥ.

$$N ( λ ) = {\sum }_{i = 1}^{2} {α}_{i} {N}_{i} = {\sum }_{i = 1}^{2} {α}_{i} {\overline{B}}_{2 {f}_{i}} + {\overline{B}}_{{2}_{i}}$$

(i=1, 2) is computed, wherein B̅_{2f}_{ᵢ}⁺ represents pseudo inverse of B̅_{2f}_{ᵢ}.

A system matrix is computed.

A_{Δ}(λ)=Ā(λ)−B̅_{2f}(λ)M(λ), B_{Δ}(λ)=B̅₂(λ)−B̅_{2f}(λ)

C_{Δ}(λ)=M(λ), D_{Δ}(λ)=N(λ)

A state space equation and a control law of the active fault tolerant controller are constructed.

$$\{ \begin{matrix}{\dot{x}}_{Δ} = {A}_{Δ} ( λ ) {x}_{Δ} + {B}_{Δ} ( λ ) {u}_{c} \\ {u}_{f} = {C}_{Δ} ( λ ) {x}_{Δ} + {D}_{Δ} ( λ ) {u}_{c} - {\overline{B}}_{2 f}^{- 1} \overline{F} ( λ ) \hat{f}\end{matrix}$$

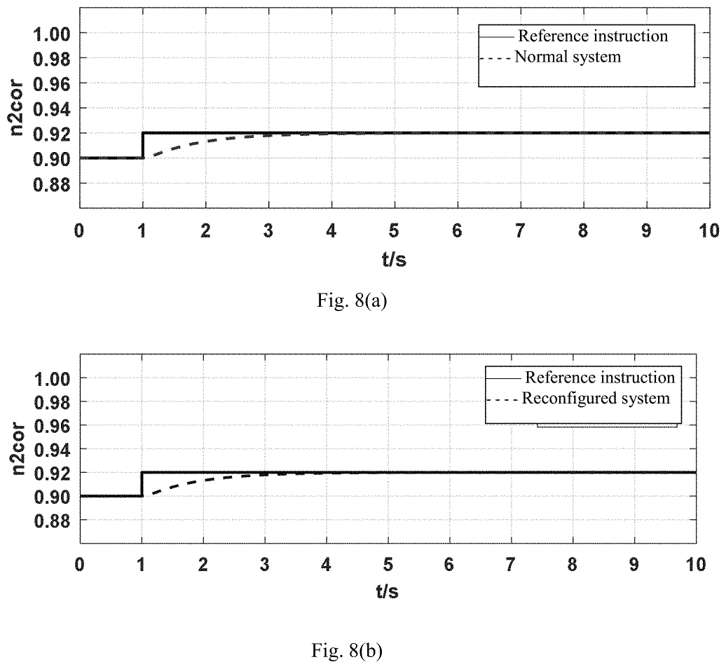

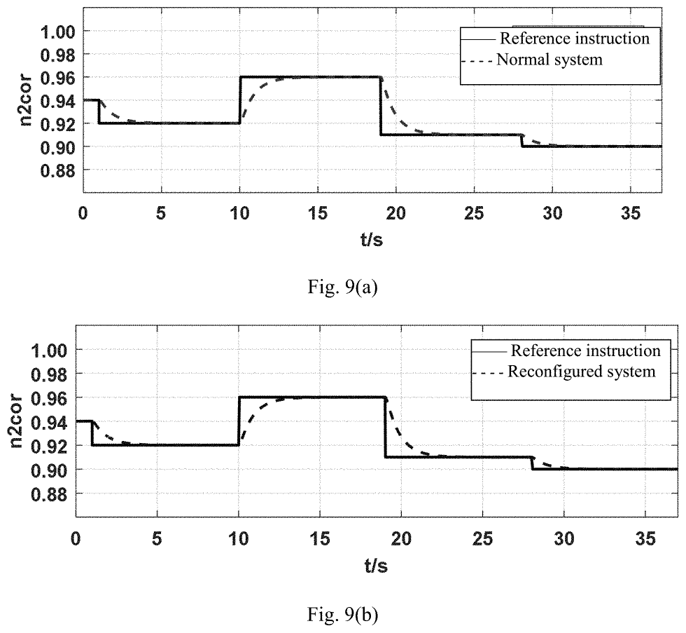

The system with fault is reconfigured by the above designed virtual actuator. FIG. 8 and FIG. 9 respectively show result comparison of normal output of the control system and the system with fault after active fault tolerant control when the relative conversion speeds of the high pressure rotors are 90% and 94%. It can be seen from the simulation results that, after the active fault tolerant controller is introduced, the control performance of the reconfigured system is similar to that of the system without fault, and the faults are hidden, thereby achieving active fault tolerance. In addition, because the virtual actuator is used for reconfiguration, the redesign of an original speed tracking controller is avoided, and the complexity of system maintenance is reduced, which is of great significance for engineering application.

1. A method for active fault tolerant control of a turbofan engine control system, comprising the following steps:
step 1: establishing a turbofan engine LPV model based on turbofan engine test experimental data:
$$\{ \begin{matrix}\dot{x} = A ( λ ) x + B ( λ ) {u}_{c} + Ed \\ y = Cx + Gd\end{matrix} \qquad ( 1 )$$
wherein x∈Rⁿ is a state variable u_{c}∈R^{m} is the control input of a turbofan engine; d∈R^{q} is a disturbance signal: output is y∈R^{p}; the value of a scheduling parameter λ is a normalized relative conversion speed of high pressure rotors of the turbofan engine; λₘᵢₙ≤λ≤λₘₐₓ; λₘᵢₙ and λₘₐₓ are respectively a minimum value and a maximum value of the scheduling parameter; system matrices are A(λ)∈R^{n×n}, B(λ)∈R^{n×m}, C∈R^{n×m}, E∈R^{n×q}, G∈R^{p×q}; R^{(⋅)} represents a (⋅)-dimensional real column vector; and R^{a×b} represents a a×b-dimensional real matrix;
step 2: designing a LPV gain scheduling robust tracking controller for the turbofan engine LPV model with disturbance;
step 2.1: introducing a new state variable xₑ, defined as
xₑ=∫₀ⁱe(s)ds=∫₀ⁱ(y(s)−yᵣ(s))ds (2)
wherein e(⋅) is a tracking error and y_{r(⋅)} is a desired tracking signal: rewriting formula (1) into a formula (3) of a generalized form
$$\{ \begin{matrix}\dot{\overline{x}} = \overline{A} ( λ ) \overline{x} + {\overline{B}}_{1} \overline{w} + {\overline{B}}_{2} ( λ ) {u}_{c} \\ \overline{z} = {\overline{C}}_{1} \overline{x} + {\overline{D}}_{11} \overline{w}\end{matrix} wherein \overline{x} = [ \begin{matrix}x \\ {x}_{e}\end{matrix} ] , \\ \overline{w} = [ \begin{matrix}d \\ {y}_{r}\end{matrix} ] , \overline{z} = [ \begin{matrix}e \\ {x}_{e}\end{matrix} ] , \overline{A} ( λ ) = [ \begin{matrix}A ( λ ) & 0 \\ C & 0\end{matrix} ] , {\overline{B}}_{1} = [ \begin{matrix}E & 0 \\ G & - I\end{matrix} ] , \\ {\overline{B}}_{2} ( λ ) = [ \begin{matrix}B ( λ ) \\ 0\end{matrix} ] , {\overline{C}}_{1} = [ \begin{matrix}C & 0 \\ 0 & I\end{matrix} ] and {\overline{D}}_{11} = [ \begin{matrix}G & - I \\ 0 & 0\end{matrix} ] ; \qquad ( 3 )$$
step 2.2: for the formula (3), constructing and solving the following linear matrix inequalities (LMIs):
$$[ \begin{matrix}( {\overline{A}}_{i} X + {\overline{B}}_{2 i} {V}_{i} ) + {( {\overline{A}}_{i} X + {\overline{B}}_{2 i} {V}_{i} )}^{T} & {\overline{B} }_{1} & {( {\overline{C}}_{1} X )}^{T} \\ 0 & - γ I & {\overline{D} }_{11}^{T} \\ 0 & 0 & - γ I\end{matrix} ] \qquad ( 4 )$$
wherein i=1, 2, Ā₂=Ā(λₘᵢₙ), Ā₂=Ā(λₘₐₓ) B̅₂₁=B̅₂(λₘᵢₙ) and B̅₂₂=B̅₂(λₘₐₓ); γ is a desired value of H_{∞} norm of a close loop transfer function T_{w̅z̅}(s) in the generalized form (3); I is an identity matrix; and the formula (4) is solved to obtain matrices X and Vᵢ;
step 2.3: computing the output of the LPV gain scheduling robust tracking controller:
$${u}_{c} = K ( λ ) x = {\sum }_{i = 1}^{2} {α}_{i} {V}_{i} {X}^{- 1} x \\ wherein K ( λ ) = {\sum }_{i = 1}^{2} {α}_{i} {V}_{i} {X}^{- 1} , {α}_{1} ( λ ) = \frac{{λ}_{max} - λ}{{λ}_{max} - {λ}_{min}} and \\ {α}_{2} ( λ ) = \frac{λ - {λ}_{min}}{{λ}_{max} - {λ}_{min}} ; \qquad ( 5 )$$
step 3: for the turbofan engine LPV model with disturbance and sensor and actuator faults, establishing an adaptive fault estimator of the turbofan engine based on a robust H_{∞} optimization method to realize fault estimation of a sensor and an actuator;
step 3.1: considering that the turbofan engine control system has the actuator and sensor faults, and expressing a system with fault as shown in formula (6):
$$\{ \begin{matrix}{\dot{x}}_{f} = A ( λ ) {x}_{f} + {B}_{f} ( λ ) u + Ed + {F}_{f} ( λ ) f \\ {y}_{f} = {Cx}_{f} + Gd + {H}_{f} ( λ ) f\end{matrix} \qquad ( 6 )$$
wherein x∈Rⁿ is a state variable of the system with fault u∈R^{m} is control input of the system with fault; y_{f}∈R^{p} is measurement output of the system with fault; f=[fₐ^{T} fₛ^{T}]^{T}∈R^{l} is a fault signal; fₐ∈R^{l}^{₁} is an actuator fault; fₛ∈R^{l}^{₂} is a sensor fault; B_{f}(λ)∈R^{n×m} is a matrix of the system with fault; and F_{f}(λ)∈R^{n×l} and H_{f}(λ)∈R^{p×l} are respectively fault matrices of the actuator and the sensor;
step 3.2: separating a time varying part from a time invariant part in the formula (6), and rewriting into the following form
$$\{ \begin{matrix}[ \begin{matrix}{\dot{x}}_{f} \\ {z}_{λ} \\ {y}_{f}\end{matrix} ] = [ \begin{matrix}A & {B}_{f 1} & {B}_{f 2} \\ {C}_{f 1} & {D}_{f 11} & {D}_{f 12} \\ {C}_{f 2} & {D}_{f 21} & {D}_{f 22}\end{matrix} ] [ \begin{matrix}{x}_{f} \\ {w}_{λ} \\ w\end{matrix} ] \\ {w}_{λ} = Λ {z}_{λ}\end{matrix} \qquad ( 7 )$$
wherein external input is w=[u^{T} d^{T} f^{T}]^{T}; z_{λ}, w_{λ}∈R^{r} are respectively input and output variables of a r-dimensional time varying subsystem Λ=λI in the formula (6): B_{f1}∈R^{n×r}, B_{f2}∈R^{n×(m+q+l)}, C_{f1}∈R^{r×n}, C_{f2}∈R^{p×n}, D_{f11}∈R^{r×r} D₁₂∈R^{r×(m+q+l)}, D_{f21}∈∈R^{p×r} and D_{f22}∈R^{p×(m+q+l)} are system state space matrices;
based on the formula (7), constructing a fault estimator state space expression as follows:
$$\{ \begin{matrix}[ \begin{matrix}{\dot{x}}_{e} \\ \hat{f} \\ {z}_{e λ}\end{matrix} ] = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] [ \begin{matrix}{x}_{e} \\ {u}_{e} \\ {w}_{e λ}\end{matrix} ] \\ {w}_{e λ} = Λ {z}_{e λ}\end{matrix} \qquad ( 8 )$$
wherein xₑ∈R^{k}, uₑ=[u^{T} Y_{f}^{T}]^{T}∈R^{(p+m)} and \hat{f}∈R^{t} respectively represent a state variable, a control input and a fault estimation output of the fault estimator; z_{eλ}∈R^{r} and w_{eλ}∈R^{r} respectively represent an input and an output of the time varying part of the fault estimator; Aₑ∈R^{k×k}, Bₑ₁∈R^{k×(m+p)}, Bₑ₂∈R^{k×r}, Cₑ₁∈R^{l×k}, Cₑ₂∈R^{r×k}, Dₑ₁₁∈R^{l×(p+m)}, Dₑ₁₂∈R^{l×r}, Dₑ₂₁∈R^{r×(p+m)} and Dₑ₂₂∈R^{r×r} are fault estimator coefficient matrices to be designed;
step 3.3: constructing a state space joint representation of the formula (7) of the system with fault of the turbofan engine and the formula (8) of the fault estimator:
$$\begin{matrix}\{ \begin{matrix}[ \begin{matrix}{\dot{x}}_{f} \\ \frac{{\dot{x}}_{e}}{{z}_{e λ}} \\ \frac{{z}_{λ}}{{e}_{f}}\end{matrix} ] = [ \begin{matrix}{A}^{\_ } & {{B}^{\_ }}_{1} & {{B}^{\_ }}_{2} \\ {\overline{C}}_{1} & {{D}^{\_ }}_{11} & {{D}^{\_ }}_{12} \\ {\overline{C}}_{2} & {{D}^{\_ }}_{21} & {{D}^{\_ }}_{22}\end{matrix} ] [ \begin{matrix}{x}_{f} \\ \frac{{x}_{e}}{{w}_{e λ}} \\ \frac{{w}_{λ}}{w}\end{matrix} ] \\ [ \begin{matrix}{w}_{λ} \\ {w}_{e λ}\end{matrix} ] = [ \begin{matrix}Λ & 0 \\ 0 & Λ\end{matrix} ] [ \begin{matrix}{z}_{λ} \\ {z}_{e λ}\end{matrix} ]\end{matrix} & ( 9 )\end{matrix}$$
wherein a fault estimate error is e_{f}=\hat{f}−f,
$$\begin{matrix}[ \begin{matrix}{A}^{\_ } & {\overline{B} }_{1} & {{B}^{\_ }}_{2} \\ {\overline{C}}_{1} & {{D}^{\_ }}_{11} & {{D}^{\_ }}_{12} \\ {\overline{C}}_{2} & {{D}^{\_ }}_{21} & {{D}^{\_ }}_{22}\end{matrix} ] = [ \begin{matrix}{A}_{0} & {B}_{01} & {B}_{02} \\ {C}_{01} & {D}_{01} & {D}_{02} \\ {C}_{02} & {D}_{03} & {D}_{04}\end{matrix} ] + [ \begin{matrix}{T}_{1} \\ {T}_{5} \\ {T}_{6}\end{matrix} ] Γ [ \begin{matrix}{T}_{2} & {T}_{3} & {T}_{4}\end{matrix} ] \\ {A}_{0} = [ \begin{matrix}A & 0 \\ 0 & 0\end{matrix} ] , {B}_{01} = [ \begin{matrix}0 & {B}_{f 1} \\ 0 & 0\end{matrix} ] , {B}_{02} = [ \begin{matrix}{B}_{f 2} \\ 0\end{matrix} ] & ( 10 ) \\ {C}_{01} = [ \begin{matrix}0 & 0 \\ {C}_{f 1} & 0\end{matrix} ] , {D}_{01} = [ \begin{matrix}0 & 0 \\ 0 & {D}_{f 11}\end{matrix} ] , {D}_{02} = [ \begin{matrix}0 \\ {D}_{f 12}\end{matrix} ] \\ {C}_{02} = [ \begin{matrix}0 & 0\end{matrix} ] , {D}_{03} = [ \begin{matrix}0 & 0\end{matrix} ] , {D}_{04} = {D}_{22} & ( 11 ) \\ {T}_{1} = [ \begin{matrix}0 & 0 & 0 \\ I & 0 & 0\end{matrix} ] , {T}_{2} = [ \begin{matrix}0 & I \\ {C}_{3} & 0 \\ 0 & 0\end{matrix} ] , {T}_{3} = [ \begin{matrix}0 & 0 \\ 0 & {D}_{31} \\ I & 0\end{matrix} ] \\ {T}_{4} = [ \begin{matrix}0 \\ {D}_{32} \\ 0\end{matrix} ] , {T}_{5} = [ \begin{matrix}0 & 0 & I \\ 0 & {D}_{13} & 0\end{matrix} ] , {T}_{6} = [ \begin{matrix}0 & {D}_{23} & 0\end{matrix} ] & ( 12 ) \\ Γ = [ \begin{matrix}{A}_{e} & {B}_{e 1} & {B}_{e 2} \\ {C}_{e 1} & {D}_{e 11} & {D}_{e 12} \\ {C}_{e 2} & {D}_{e 21} & {D}_{e 22}\end{matrix} ] {C}_{3} = [ \begin{matrix}0 \\ {C}_{f 2}\end{matrix} ] , {D}_{22} = [ \begin{matrix}0 & - I \\ 0 & 0\end{matrix} ] , \\ {D}_{23} = [ \begin{matrix}I \\ 0\end{matrix} ] , {D}_{31} = [ \begin{matrix}0 \\ {D}_{f 21}\end{matrix} ] , {D}_{32} = [ \begin{matrix}I & 0 & 0 \\ & {D}_{f 22} & \end{matrix} ] & ( 13 )\end{matrix}$$
and Γ are estimation matrices of the fault estimator;
step 3.4: setting
$$X = [ \begin{matrix}L & V \\ {V}^{T} & Y\end{matrix} ] , {X}^{- 1} = [ \begin{matrix}J & W \\ {W}^{T} & Z\end{matrix} ]$$
wherein L, V and Y respectively represent sub-block matrices of X; and J, W and Z respectively represent sub-block matrices of X⁻¹;
constructing a matrix P and an inverse matrix \tilde{P} as shown in formula (14):
$$P = [ \begin{matrix}Q & S \\ {S}^{T} & R\end{matrix} ] = [ \begin{matrix}{Q}_{1} & {Q}_{2} & {S}_{1} & {S}_{2} \\ {Q}_{2}^{T} & {Q}_{3} & {S}_{3} & {S}_{4} \\ {S}_{1}^{T} & {S}_{3}^{T} & {R}_{1} & {R}_{2} \\ {S}_{2}^{T} & {S}_{4}^{T} & {R}_{2}^{T} & {R}_{3}\end{matrix} ] , \\ {P}^{- 1} = \tilde{P} = [ \begin{matrix}\tilde{Q} & \tilde{S} \\ {\tilde{S}}^{T} & \tilde{R}\end{matrix} ] = [ \begin{matrix}{\tilde{Q}}_{1} & {\tilde{Q}}_{2} & {\tilde{S}}_{1} & {\tilde{S}}_{2} \\ {\tilde{Q}}_{2}^{T} & {\tilde{Q}}_{3} & {\tilde{S}}_{3} & {\tilde{S}}_{4} \\ {\tilde{S}}_{1}^{T} & {\tilde{S}}_{3}^{T} & {\tilde{R}}_{1} & {\tilde{R}}_{2} \\ {\tilde{S}}_{2}^{T} & {\tilde{S}}_{4}^{T} & {\tilde{R}}_{2}^{T} & {\tilde{R}}_{3}\end{matrix} ] \qquad ( 14 )$$
wherein Q₁, Q₂ and Q₃ respectively represent sub-block matrices of Q; S₁, S₂, S₃ and S₄ respectively represent sub-block matrices of S; R₁, R₂ and R₃ respectively represent sub-block matrices of R; \tilde{Q}, \tilde{S} and \tilde{R} respectively represent sub-block matrices of \tilde{P}; \tilde{Q}₁, \tilde{Q}₂ and \tilde{Q}₃ respectively represent sub-block matrices of \tilde{Q}; \tilde{S}₁, \tilde{S}₂, \tilde{S}₃ and \tilde{S}₄ respectively represent sub-block matrices of \tilde{S}; \tilde{R}₁, \tilde{R}₂ and \tilde{R}₃ respectively represent sub-block matrices of \tilde{R};
constructing the following LMIs, and combining to solve corresponding matrix solutions L, J, Q₃, R₃, S₄, \tilde{Q}₃, \tilde{R}₃ and \tilde{S}₄:
$$\begin{matrix}{{N}_{L}^{T} [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ]}^{T} [ \begin{matrix}0 & 0 & 0 & L & 0 & 0 \\ 0 & {Q}_{3} & 0 & 0 & {S}_{4} & 0 \\ 0 & 0 & - γ I & 0 & 0 & 0 \\ L & 0 & 0 & 0 & 0 & 0 \\ 0 & {S}_{4}^{T} & 0 & 0 & {R}_{3} & 0 \\ 0 & 0 & 0 & 0 & 0 & {γ}^{- 1} I\end{matrix} ] [ \begin{matrix}I & 0 & 0 \\ 0 & I & 0 \\ 0 & 0 & I \\ A & {B}_{f 1} & {B}_{f 2} \\ {C}_{f 1} & {D}_{f 11} & {D}_{f 12} \\ 0 & 0 & {D}_{22}\end{matrix} ] {N}_{L} < 0 & ( 15 ) \\ {{N}_{J}^{T} [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ]}^{T} [ \begin{matrix}0 & 0 & 0 & J & 0 & 0 \\ 0 & {\tilde{Q}}_{3} & 0 & 0 & {\tilde{S}}_{4} & 0 \\ 0 & 0 & - {γ}^{- 1} I & 0 & 0 & 0 \\ J & 0 & 0 & 0 & 0 & 0 \\ 0 & {\tilde{S}}_{4}^{T} & 0 & 0 & {\tilde{R}}_{3} & 0 \\ 0 & 0 & 0 & 0 & 0 & γ I\end{matrix} ] [ \begin{matrix}- {A}^{T} & - {C}_{f 1}^{T} & 0 \\ - {B}_{f 1}^{T} & - {D}_{f 11}^{T} & 0 \\ - {B}_{f 2}^{T} & - {D}_{f 12}^{T} & - {D}_{22}^{T} \\ I & 0 & 0 \\ 0 & I & 0 \\ 0 & 0 & I\end{matrix} ] {N}_{J} > 0 & ( 16 ) \\ [ \begin{matrix}J & I \\ I & L\end{matrix} ] > 0 & ( 17 ) \\ R > 0 , Q = - R , S + {S}^{T} = 0 & ( 18 )\end{matrix}$$
wherein N_{L} and N_{J} are respectively the bases of the nuclear spaces of [C₃ D₃₁ D₃₂] and [0 D₁₃^{T} D₂₃^{T}];
step 3.5: further, solving X in the formula (17) according to a solving result of the step 3.4;
$$X [ \begin{matrix}J & I \\ {W}^{T} & 0\end{matrix} ] = [ \begin{matrix}I & L \\ 0 & {V}^{T}\end{matrix} ] \qquad ( 17 )$$
solving P according to P\tilde{P}=I;
step 3.6: solving the following LMIs to obtain an estimation matrix Γ of the fault estimator:
$$Ψ + {\overline{P}}^{T} {Γ}^{T} {\overline{Q}}_{X} + {\overline{Q}}_{X}^{T} Γ \overline{P} < 0 \\ wherein Ψ = [ \begin{matrix}{A}_{0}^{T} X + {XA}_{0} & {XB}_{01} + {C}_{01}^{T} {S}^{T} & {XB}_{02} & {C}_{01}^{T} & {C}_{02}^{T} \\ {SC}_{01} + {B}_{01}^{T} {X}^{T} & Q + {D}_{01}^{T} {S}^{T} + {SD}_{01} & {SD}_{02} & {D}_{01}^{T} & {D}_{03}^{T} \\ {B}_{02}^{T} {X}^{T} & {D}_{02}^{T} {S}^{T} & - γ I & {D}_{02}^{T} & {D}_{04}^{T} \\ {C}_{1} & {D}_{01} & {D}_{02} & - \tilde{R} & 0 \\ {C}_{02} & {D}_{03} & {D}_{4} & 0 & - γ I\end{matrix} ] \\ \overline{P} = [ \begin{matrix}{T}_{2} & {T}_{3} & {T}_{4} & 0 & 0\end{matrix} ] , {\overline{Q}}_{X} = [ \begin{matrix}{T}_{1}^{T} X & {T}_{5}^{T} {S}^{T} & 0 & {T}_{5}^{T} & {T}_{6}^{T}\end{matrix} ] \qquad ( 19 )$$
further, computing a coefficient matrix of the fault estimator:
$$[ \begin{matrix}{A}_{E} ( λ ) & {B}_{E} ( λ ) \\ {C}_{E} ( λ ) & {D}_{E} ( λ )\end{matrix} ] = [ \begin{matrix}{A}_{e} & {B}_{e 1} \\ {C}_{e 1} & {D}_{e 11}\end{matrix} ] + [ \begin{matrix}{B}_{e 2} \\ {D}_{e 12}\end{matrix} ] {Λ ( I - {D}_{e 22} Λ )}^{- 1} [ \begin{matrix}{C}_{e 2} & {D}_{e 21}\end{matrix} ] \qquad ( 20 )$$
step 4: designing an active fault tolerant controller of a turbofan engine based on a virtual actuator according to a fault estimation result; and without redesigning the controller, making the control system stable and obtaining a control effect similar to that of the system without fault;
step 4.1: considering the system with fault of the turbofan engine; and when the sensor and actuator faults exist, designing the virtual actuator based on a reconfiguration principle, with a state space model representation of a reconfigured system as follows:
$$\{ \begin{matrix}[ \begin{matrix}{\dot{\overline{x}}}_{f} \\ {\dot{x}}_{Δ}\end{matrix} ] = [ \begin{matrix}\overline{A} ( λ ) & {\overline{B}}_{2 f} ( λ ) {C}_{Δ} ( λ ) \\ 0 & {A}_{Δ} ( λ )\end{matrix} ] [ \begin{matrix}{\overline{x}}_{f} \\ {x}_{Δ}\end{matrix} ] + [ \begin{matrix}{\overline{B}}_{1} \\ 0\end{matrix} ] \overline{w} + [ \begin{matrix}{\overline{B}}_{2 f} ( λ ) {D}_{Δ} ( λ ) \\ {B}_{Δ} ( λ )\end{matrix} ] {u}_{c} \\ {z}_{re} = [ \begin{matrix}{\overline{C}}_{1} & 0\end{matrix} ] [ \begin{matrix}{\overline{x}}_{f} \\ {x}_{Δ}\end{matrix} ] + {\overline{D}}_{11} \overline{w} \\ {x}_{c} = [ \begin{matrix}I & I\end{matrix} ] [ \begin{matrix}{\overline{x}}_{f} \\ {x}_{Δ}\end{matrix} ]\end{matrix} wherein {x}_{f} = [ \begin{matrix}{x}_{f} \\ {x}_{ef}\end{matrix} ] ; {x}_{ef} = {\int }_{0}^{t} {e}_{f} ( s ) ds = {\int }_{0}^{t} ( {y}_{f} ( s ) - {y}_{r} ( s ) ) ds ; \qquad ( 21 )$$
x_{Δ} is a state variable of the virtual actuator;
$${\overline{B}}_{2 f} ( λ ) = [ \begin{matrix}{B}_{f} ( λ ) \\ 0\end{matrix} ] ; {A}_{Δ} ( λ ) = \overline{A} ( λ ) - {\overline{B}}_{2 f} ( λ ) M ( λ ) ;$$
$${B}_{Δ} ( λ ) = {B}_{2} ( λ ) - {\overline{B}}_{2 f} ( λ ) N ( λ ) ; \overline{w} = [ \begin{matrix}d \\ {y}_{r}\end{matrix} ] ; {C}_{Δ} ( λ ) = M ( λ ) ;$$
$${D}_{Δ} ( λ ) = N ( λ ) ; {\overline{C}}_{1} = [ \begin{matrix}C & 0 \\ 0 & I\end{matrix} ] ; {\overline{D}}_{11} = [ \begin{matrix}G & - I \\ 0 & 0\end{matrix} ] , {x}_{c} = {x}_{Δ} + {\overline{x}}_{f} ;$$
zᵣₑ is a controlled output of the reconfigured system; M(λ) and N(λ) are to-be-solved matrices in an active fault tolerant control law;
solving positive definite matrices Xᵥ, Y₁ and Y₂ according to LMIs combined by (22)-(24);
$$\begin{matrix}{\overline{A}}_{i} {X}_{v} - {\overline{B}}_{2 {f}_{i}} {Y}_{i} + {X}_{v} {\overline{A}}_{i}^{T} - {Y}_{i}^{T} {\overline{B}}_{2 {f}_{i}}^{T} + 2 ρ {X}_{v} < 0 & ( 22 ) \\ [ \begin{matrix}- {rX}_{v} & {qX}_{c} + {\overline{A}}_{i} {X}_{v} - {\overline{B}}_{2 {f}_{i}} {Y}_{i} \\ * & - {rX}_{v}\end{matrix} ] < 0 & ( 23 ) \\ [ \begin{matrix}sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} ) & cos ( θ ) ( \begin{matrix}{\overline{A}}_{i} {X}_{v} - {\overline{B}}_{2 {f}_{i}} {Y}_{i} - \\ {X}_{v} {\overline{A}}_{i}^{T} - {Y}_{i}^{T} {\overline{B}}_{2 {f}_{i}}^{T}\end{matrix} ) \\ cos ( θ ) ( \begin{matrix}{X}_{v}^{T} {\overline{A}}_{i}^{T} - {Y}_{i} {\overline{B}}_{2 {f}_{i}}^{T} - \\ {\overline{A}}_{i} {X}_{v}^{T} - {\overline{B}}_{2 {f}_{i}} {Y}_{i}\end{matrix} ) & sin ( θ ) ( \begin{matrix}{\overline{A}}_{i} {X}_{v} - {\overline{B}}_{2 {f}_{i}} {Y}_{i} + \\ {X}_{v} {\overline{A}}_{i}^{T} - {Y}_{i}^{T} {\overline{B}}_{2 {f}_{i}}^{T}\end{matrix} )\end{matrix} ] < 0 & ( 24 )\end{matrix}$$
wherein i=1,2; ρ is a minimum decay rate of an LMI region; r is a radius of the LMI region; q is a center of a circle; θ is an intersection angle of close loop poles and a transverse axis in the LMI region;
step 4.2: obtaining a matrix Mᵢ according to Yᵢ=MᵢXᵥ;
step 4.3: computing
$$N ( λ ) = {\sum }_{i = 1}^{2} {α}_{i} {N}_{i} = {\sum }_{i = 1}^{2} {α}_{i} {\overline{B}}_{2 {f}_{i}}^{+} {\overline{B}}_{{2}_{i}} ,$$
wherein B̅_{2f}_{ᵢ}⁺ represents pseudo inverse of B̅_{2f}_{ᵢ};
step 4.4: computing a system matrix;
A_{Δ}(λ)=Ā(λ)−B̅_{2f}(λ)M(λ), B_{Δ}(λ)=B̅₂(λ)−B̅_{2f}(λ)
C_{Δ}(λ)=M(λ), D_{Δ}(λ)=N(λ)
constructing a state space equation and a control law of the active fault tolerant controller:
$$\{ \begin{matrix}{\dot{x}}_{Δ} = {A}_{Δ} ( λ ) {x}_{Δ} + {B}_{Δ} ( λ ) {u}_{c} \\ {u}_{f} = {C}_{Δ} ( λ ) {x}_{Δ} + {D}_{Δ} ( λ ) {u}_{c} - {\overline{B}}_{2 f}^{- 1} \overline{F} ( λ ) \hat{f}\end{matrix} . \qquad ( 25 )$$
